(19) United States
(12) Patent Application Publication
(10) Pub. No.: US 2025/0388312 A1
(43) Pub. Date: Dec. 25, 2025

(54) AGRICULTURAL ROBOT SYSTEMS AND METHODS

(71) Applicant: PURDUE RESEARCH FOUNDATION, West Lafayette, IN (US)

(72) Inventors: Dongming GAN, West Lafayette, IN (US); Xiaotong HUANG, West Lafayette, IN (US); Han LIN, West Lafayette, IN (US); Jiayu LUO, West Lafayette, IN (US)

(21) Appl. No.: 19/245,018

(22) Filed: Jun. 20, 2025

Related U.S. Application Data
(60) Provisional application No. 63/662,361, filed on Jun. 20, 2024.

(51) Int. Cl. B64B 1/42; B25J 9/00; B25J 11/00

(52) U.S. Cl. CPC B64B 1/42; B25J 9/0009; B25J 11/008

(57) ABSTRACT

Agricultural robot systems and methods are disclosed. Embodiments include a robot that maneuvers at the top of a crop field while minimizing disturbance and damage to the crops. Some embodiments include a housing coupled to a balloon that provides buoyancy to the robot system, which can reduce frictional contact with the crops and increase energy efficiency. The housing can include a processor, an energy source and/or a control unit. Embodiments include a repositioning system, and the repositioning system can include one or more arms that can contact a crop to alter the position and/or direction of the agricultural robot system while avoiding crop damage and/or crop disturbance.

This application claims the benefit of U.S. Provisional Application No. 63/662,361, filed 20 Jun. 2024, the entirety of which is hereby incorporated herein by reference.

### FIELD

Embodiments of the present disclosure relate generally to agricultural systems, and to robotic crop management systems.

### INTRODUCTION

This section provides background information related to the present disclosure which is not necessarily prior art.

Agricultural robots and unmanned vehicles have helped transform farming, enhancing both convenience and efficiency. Today, agricultural robots can present a multitude of benefits including precision, efficiency and scalability. By automating intricate tasks, robots can drastically reduce reliance on manual labor, leading to significant cost savings and diminishing the margin for human error. Capable of continuous operation, robots can provide continuous and uninterrupted surveillance and care of crops. Their versatility can enable them to navigate diverse terrains and withstand changing weather conditions. Additionally, when integrated with sensors, robots can collate and analyze real-time data, paving the way for informed decisions, timely intervention, and increased crop yields.

Monitoring the health status of the crop has been a part of agricultural production for some time. Any infectious disease in a crop that went unnoticed were able to cause financial loss to the owner of the crop field. Infectious diseases can spread rapidly from one crop to its surroundings through the soil or above the soil, eventually leading to the death of a larger area of crops. And, while agricultural robots have been used for increasing crop yields, challenges persist in close-distance crop health monitoring. Currently the agricultural sector utilizes two primary robot categories: Unmanned Ground Vehicles (UGVs) and Unmanned Aerial Vehicles (UAVs).

UGVs, including the Autonomous Seed-Planting Vehicle, the RHEA Fleet, the DEDALO UGV, and innovations from Wageningen University (Netherlands), encounter limitations in crop health assessment due to their sensitivity to field topography, size and weight requirements. These constraints can negatively affect the energy efficiency (such as in electric models) or environmental impact (such as increasing fuel consumption) it existing agricultural robots.

UAVs, on the other hand, which include fixed-wing, helicopter, and multi-copter (e.g., quadcopter, hexacopter and octocopter) models, must maintain a certain altitude above the crops to avoid crop damage, thus hindering close-range scanning capabilities. Rotary-wing drones, while capable of hovering, face challenges in carrying needed equipment due to weight constraints.

It was realized by the inventors of the current disclosure that problems exist with current agricultural robots and that improvements, such as increased energy efficiency and the ability to perform tasks closer to crops without damaging or moving the tops of the crops, are needed.

Certain preferred features of the present disclosure address these and other needs and provide other important advantages.

### SUMMARY

Given the limitations inherent in conventional agricultural robots, the inventors of the present disclosure conceived of a robotic system that was capable of approaching crops and crop leaves without damaging and/or disturbing the crops and crop leaves, such as a robotic system whose weight is predominantly, if not entirely, carried by a lighter than air device, such as a balloon, and in some embodiments coupled with a propulsion system that gently contacts the upper portions of the crop.

Embodiments of the present disclosure can provide close distance monitoring of a crop field while minimizing damage and movement of the crop field as the robot moves about the crop field, setting themselves apart from both ground-based vehicles and aerial drones. A concept picture is show in FIG. 1. This buoyant design not only decreases frictional contact with crops but also enhances energy efficiency. At least one objective of the inventors is to translate the conceptual framework into tangible prototypes, and to evaluating these embodiments using metrics such as navigational routes, speed and overall operational duration on a single battery charge.

In concordance with the instant disclosure, an agricultural robot system that may enhance energy efficiency and/or may perform tasks closer to crops without damaging the crops has surprisingly been discovered.

Given the limitations inherent to conventional agricultural robots, the present disclosure provides an agricultural robot that decreases the weight of the robot, such as by utilizing a balloon. This distinctive robot defies categorization, setting itself apart from both ground-based vehicles and aerial drones, and in some respects performing in a similar manner to a watercraft. The balloon can provide buoyancy to the agricultural robot while decreasing frictional contact with crops and/or increasing energy efficiency. The agricultural robot system may include a housing coupled to the balloon. The housing may include a processor. The agricultural robot system may also include a repositioning system. The repositioning system may include an arm that can push against one or more plants, and in some embodiments may rotate to generate the pushing force. In at least one embodiment, the arm may include a paddle. In one or more additional embodiments, the repositioning system may include a plurality of paddles.

Embodiments of the present disclosure provide an improved agricultural robot systems and methods.

Further areas of applicability will become apparent from the description provided herein. The description and specific examples in this summary are intended for purposes of illustration only and are not intended to limit the scope of the present disclosure.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

The drawings described herein are for illustrative purposes of example embodiments only and are not intended to limit the scope of the present disclosure. Not all possible embodiments and implementations are illustrated. Some of the figures shown herein may include dimensions or may have been created from scaled drawings; however, such dimensions, or the relative scaling within a figure, are by way of example, and are not to be construed as limiting.

FIG. 1 is a perspective view of an agricultural robot system having a housing, a balloon and a repositioning system and disposed on an agricultural field according to at least one embodiment of the present disclosure.

FIGS. 2A-2D are perspective views of an agricultural robot system having a housing coupled to a repositioning system, and depicting different types of maneuvering that may be accomplished by the repositioning system according to at least one embodiment of the present disclosure.

FIG. 3 is a schematic diagram of a controller, processor and motor of an agricultural robot system according to at least one embodiment of the present disclosure.

FIG. 4 is a perspective view of the agricultural robot system including a balloon being substantially Zeppelin-shaped according to at least one embodiment of the present disclosure.

FIG. 5 is a bottom plan view of an agricultural robot system according to at least one embodiment of the present disclosure.

FIG. 6 is a top plan view of an agricultural robot system and a free body diagram or analysis according to at least one embodiment of the present disclosure.

FIG. 7 includes line graphs depicting motor torque, trajectory, velocity and angular velocity during a first simulation of an agricultural robot system according to at least one embodiment of the present disclosure.

FIG. 8 depicts a Free Body Diagram (FBD) used in the analysis of an agricultural robotic system according to embodiments of the present disclosure.

FIG. 9 illustrates line graphs depicting a circular trajectory, velocity, angular velocity and motor torque during a simulation of an agricultural robot system according to at least one embodiment of the present disclosure.

FIG. 10 illustrates line graphs depicting a random curved trajectory, velocity, angular velocity, and motor torque during a simulation of an agricultural robot system according to at least one embodiment of the present disclosure.

FIG. 11 is a flow chart of a method for using the agricultural robot system according to at least one embodiment of the present disclosure.

### DETAILED DESCRIPTION OF THE ILLUSTRATED EMBODIMENTS

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the Fig. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Embodiments of the new agricultural robot concept include a balloon robot 100, which can include laterally positioned twin wheel paddles 134 and at least one balloon 110 on the top of the robot 100. The balloon robot 100 is able to float and move on the top of a crop field in a similar manner as a boat moving on the surface of the water.

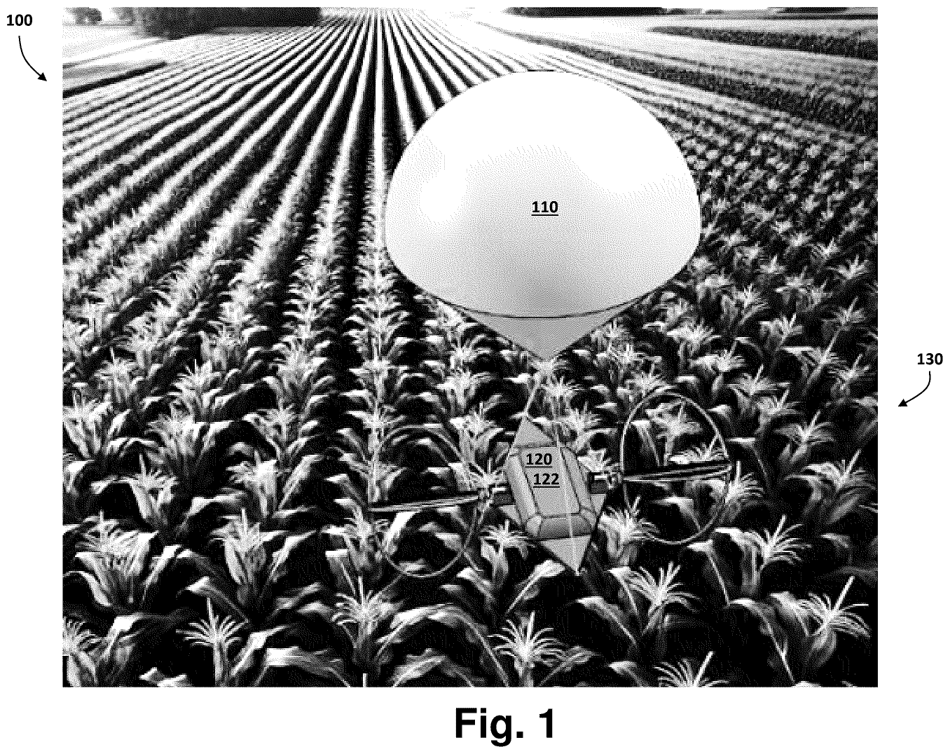

As shown in FIG. 1, at least one embodiment of the agricultural robot system 100 includes a housing 120 coupled to a balloon 110. The housing 120 may include one or more processors 122. The agricultural robot 100 system may also include a repositioning system 130. The repositioning system 130 may include an arm 132. In at least one example, the arm 132 may include one or more paddles 134, and in at least some examples the one or more paddles 134 may form a paddle wheel. In some examples, the repositioning system 130 may include a plurality of paddles 134, which may take the form of two or more paddle wheels. In some embodiments, a first paddle 134 may be coupled to a first side of the housing 120 and a second paddle 134 may be coupled to a second side of the housing 120. The first side of the housing 120 may be substantially opposite the second side of the housing 120. The processor(s) 122 may include an energy storage system 150 and a control unit 122 coupled to one or more motors 155 (e.g., servo motors) and/or relays 160 of the repositioning system 130.

Embodiments of the balloon robot 100 are able to pause in the middle of the crop field, such as to perform a function (such as collecting data), in a similar manner as a boat stopping in the middle of a lake or river. The balloon 110 provides a buoyancy force so that the robot 100 floats at the top of the crop. In some embodiments the buoyancy force is slightly less than the weight of the entire weight of the robot 100 (i.e., the weight of all components of robot 100 before the lighter-than-air gas is added to the balloon(s) 110) to provide a small amount of return force to the crop to return the robot 100 to the crop in the event that the robot 110 obtains an upward velocity. IN other words, the robot 100 can have a slightly negative buoyancy to provide a new downward weight of the robot 100 on the crops to maintain engagement of the paddles 134 with the crop.

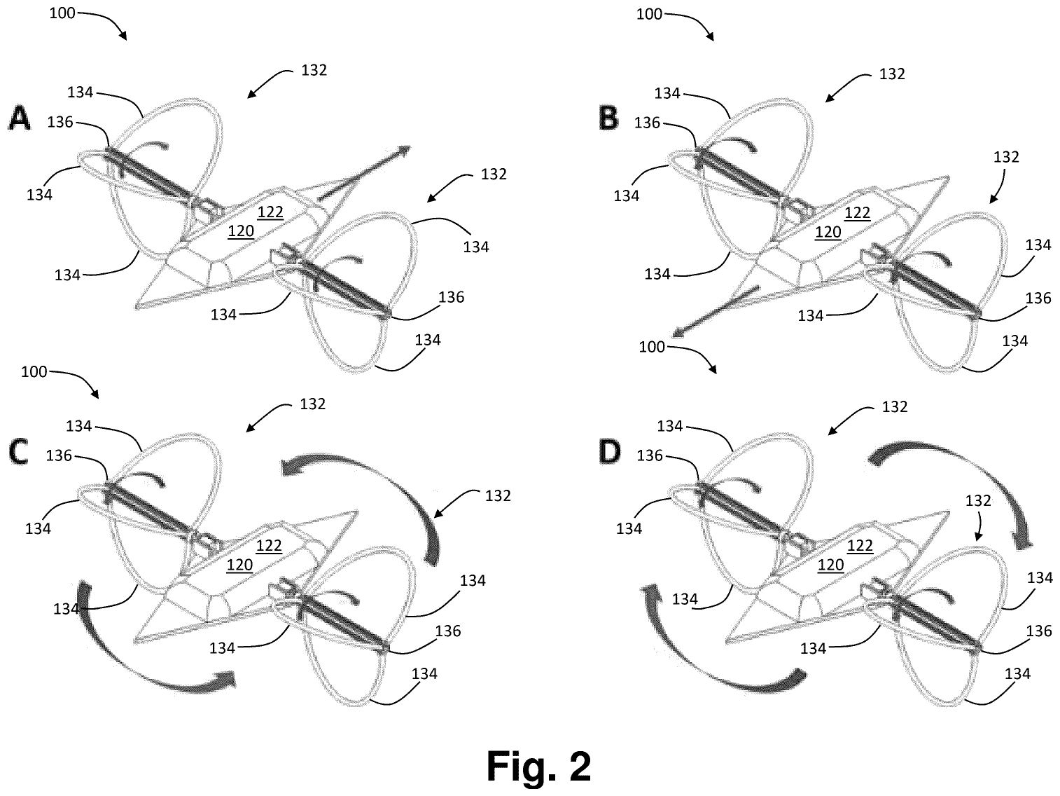

The amount of buoyancy may be adjusted depending on the type of crop and how fragile the crop is. The wheel paddles 134, which may be part of the arms 132 of the robot 100, can serve as a propulsion system that can move the robot 100 while the robot is floating on the top portion of the crop. With laterally spaced wheel paddles, the robot 100 can behave in a similar manner to a ground vehicle with a differential wheel system. When the two paddles 134 are moved in the same rotation direction, the robot moves forward (FIG. 2A) or backward (FIG. 2B) depending on the direction of rotation of the wheel paddles 134. When the two paddles 134 move in different rotational directions, the entire robot 100 rotates and changes its direction (FIGS. 2C and 2D).

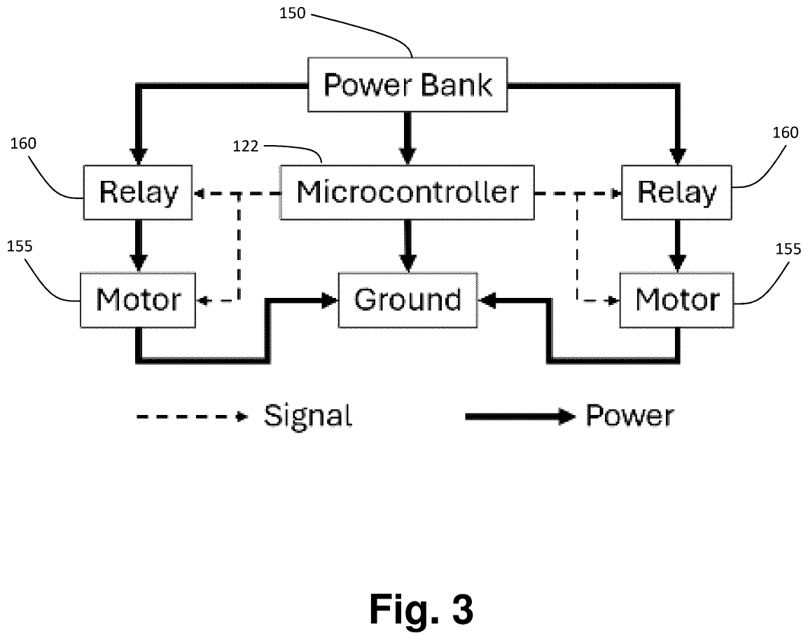

As shown in FIG. 3, the energy storage system 150 (e.g., a power bank) may be electrically coupled to the one or more processors 122 (e.g., a control unit including a microcontroller) and/or one or more motors 155 of the repositioning system 130. In at least one example the control unit may include a controller (e.g., an Arduino Uno microcontroller) which may control the engagement of the motor 155 and/or the relay 160 of the repositioning system 130. The control unit may further control a speed and/or a direction of the agricultural robot system 100 by modulating the direction of the motor 155 through signal variation and adjusting motor torque via frequency alterations in the relay 160. This relay modulation may enable the motor 155's input power to fluctuate, correspondingly altering the motor 155's output torque.

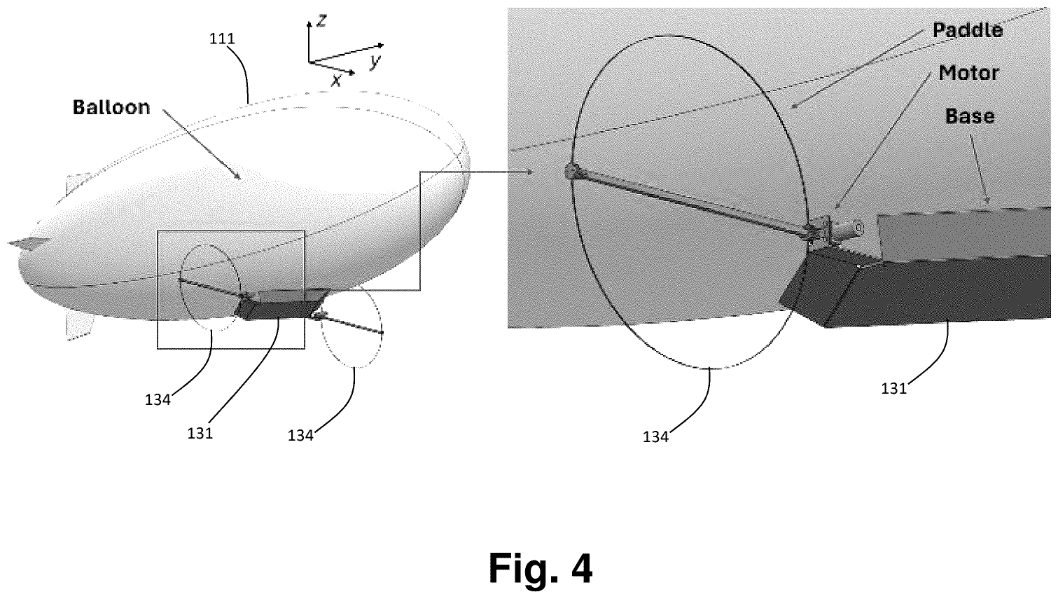

The balloon 110 may be provided in various ways to provide a sufficient buoyancy to the agricultural robot system 100. For instance, the balloon 110 may be at least partially filled with helium or another gas that has a lower density than air. The balloon 110 may be provided as a single balloon 110 or as a plurality of balloons 110. In a specific example, the balloon 110 may include a singular large unit or multiple smaller units. To ensure the robot 100 hovers over crops without ascending excessively, a delicate balance may be maintained where the buoyancy force counteracts the robot 100's gravitational pull but may not exceed it. This equilibrium may be critical to minimize both the pressure exerted on the crops and the friction between the robot 100 and the vegetation. The balloon 110 may be provided with various shapes and sizes. For instance, the balloon 110 may include a substantially circular cross-sectional shape and/or a substantially ovular cross-sectional shape. The balloon 110 may also include a stabilization feature, such as a rudder, to provide enhanced stabilization and control of the agricultural robot system 100. In the example embodiment depicted in FIG. 4, the ballon shape may include a Zeppelin-shaped balloon 111. The Zeppelin-shaped balloon 111 may be streamlined, which can facilitate the calculation of drag force and assist with creating control algorithms for repositioning the system. One skilled in the art may select other suitable ways to provide the balloon 110, within the scope of the present disclosure.

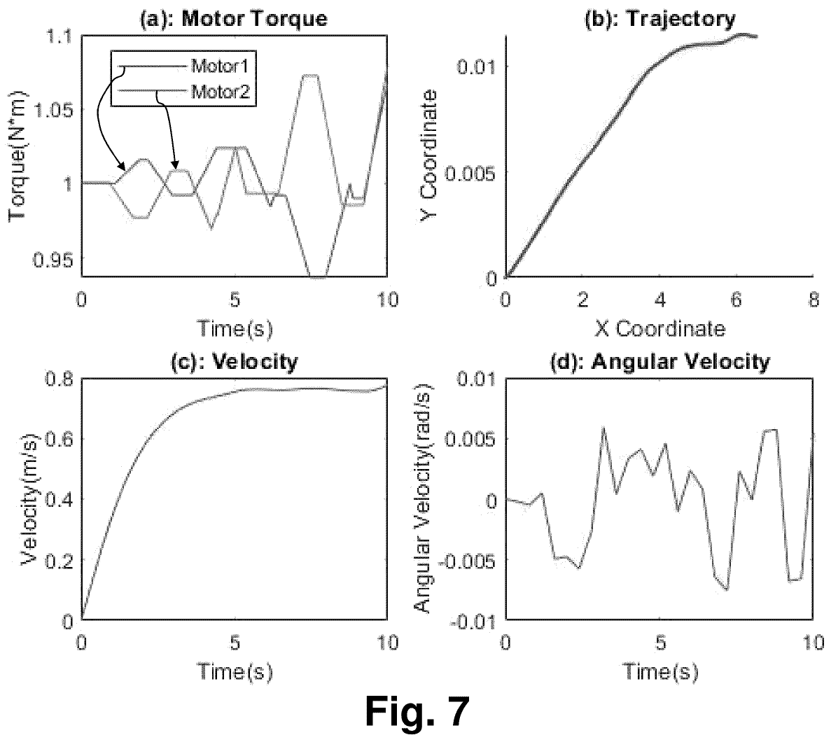

The housing 120 may be provided in various ways. For instance, the housing 120 may be configured to minimize resistance while navigating over crops. In a specific example, the housing 120 may include a tapered surface which may reduce the surface area of the housing 120 that may contact a crop. Provided as a non-limiting example, the housing 120 may be shaped substantially similar to a hull of a ship (see, e.g., FIGS. 4 and 7), where the tapered surface is configured to minimize the contact and/or resistance of the housing 120 while navigating over crops. In a more specific example, the housing 120 may include a substantially diamond-shaped cross section, which may be diamond-shaped when viewed from the top or bottom, as depicted in FIG. 3. The housing 120 may include a width configured to provide sufficient spacing between the repositioning system 130 and the balloon 110. For instance, the width of the housing 120 may be selected to provide sufficient clearance between the one or more paddles 134 and the balloon 110/111 during operation of the agricultural robot system 100. In certain circumstances, the housing 120 may include particular features and components suitable for particular agricultural purposes such as sensors, cameras, sprayers, navigation systems, etc. Moreover, the housing 120 may include a communication system facilitating the ability to remotely communicate with the robot 100, such as to enable a user to remotely control and/or receive information from the agricultural robot system 100. The communication system may specifically enable a user to send instructions to the control unit 122. It is contemplated that the agricultural robot system 100 may be remotely controlled, semi-autonomously controlled or fully autonomous controlled based on a predetermined and/or provided set of instructions.

The repositioning system 130 may be provided in various ways. For instance, as shown in embodiments depicted in FIGS. 2 and 4, the repositioning system 130 may include a motor 155 and a paddle 134. In a specific example, the paddle 134 may include an arm 132 coupled to an axle 136. The axle may be rotated by engagement with the motor 155, the movement of the motor 155 translating to rotation of the arm 132. The arm 132 may be configured to contact or otherwise push against crops (e.g., the tops portions of the crops) and/or a surface (e.g., the ground). It is contemplated that the arm 132 may be rigid or flexible. A portion of the arm 132 can extend away from a center of rotation and form an apex, and may have arcuate, curved and/or linear portions, and can form various geometric shapes such as circles, ovals, ellipses, triangles, squares, etc. In some example embodiments the arm 132 may include a first terminal end and a second terminal end. The first terminal end of the arm 132 and/or the second terminal end of the arm 132 may be coupled to the axle 136. In at least one example embodiment, the arm 132 may be curved, e.g., circular, ellipsoidal and/or arcuate.

In some embodiments, the arm 132 is more rigid in one dimension than another. For example, in at least one embodiment the cross section of the arm 132 is rectangular, and in some embodiments the portion of the arm 132 that contacts the crop (the portion of the arm 132 farthest away from the axle in the example illustrated in FIG. 1) is oriented with the thinner dimension of the rectangular cross section being oriented in the radial direction of the axle and the thicker dimension of the rectangular cross section being oriented in the direction of rotation of the arm 132 in order to allow the arm 132 to flex more in the radial direction of the axle allowing a cushioning of the arm 132 against the crop and flex less in the direction of rotation of the arm 132 to provide the ability to push against the crop. In additional embodiments, the cross-sectional area is elliptical or oval. In some embodiments the arm 132 includes a strip portion that contacts the crop and may be shaped differently and/or may include different materials. The arm 132 and/or strip may be manufactured from a carbon fiber material, or another lightweight structural material. In example embodiments, the strip may be sufficiently rigid to push the crops without bending while maintaining a softness to prevent crop damage. In certain circumstances, a plurality of arms 132 may be coupled to the axle.

An embodiment of the present disclosure that was used as a model for motion analysis is depicted in FIG. 4. A Computer-Aid Design (CAD) of the embodiment was used for modeling and analysis. In this embodiment, the balloon 111 was attached right above the base 131 of the robot. The balloon 111 provided buoyancy force to the robot to achieve the function of floating. Each side of the robot had one wheel-paddle 134. Both paddles 134 were driven by at least one motor (which in some embodiments is at least one servo motor) to achieve the function of moving. Both motors were controlled by a control unit, which was contained in the base 131 of the robot. The base 131 also provided a platform for other devices, e.g., transmitters, receivers, sensors, positioning/navigation systems, cameras and/or sprayers to name a few.

At least one consideration in selecting components of the robot is to have them as light as possible. The weight of the robot determines the necessary buoyancy force, and a decrease in the required buoyancy force results in a decrease in the size of the balloon 111. As the necessary component of the robot, the size of the balloon 111 helped determine the size of the robot. Decreasing the size of the robot not only decreased the drag force, but also decreased the cost of the robot. However, since many electronic devices are made with metal, additional electronics can significantly increase the total weight.

The balloon 111 is an important part of the robotic system. The balloon 111 system can be a single balloon or multiple balloons. The single balloon 111 with a Zeppelin shape was chosen as an ideal design for analysis since the Zeppelin shape is a well-known shape.

The balloon 111 was filled with helium gas to provide buoyancy force. The buoyancy force given by the balloon 111 had to be no greater than the mass of the entire robot, so the robot was not going to float away. At the same time, the buoyancy force was set to be as great as possible to avoid the robot settling onto the crops, which would increase the likelihood of damaging the plants and increase the friction force while moving.

The base 131 of the robot was designed to hold balloon 111 and wheel paddles 134, while also being able to carry all necessary electronic devices. The base 131 of the robot was designed in a boat-shape to minimize resistance. The exposed surfaces of the base 131 were optionally smooth to reduce friction. The material of the base 131 was sufficiently hard to carry the electronic devices without deformation and the size of the base 131 was large enough to carry the electronic devices as well. The base 131 of the ideal model was designed into a diamond shape.

The paddles 134 were the propulsion system of the robot. The paddles 134 were positioned far enough laterally from the base 131 so that the paddles 134 would not contact the balloon 111 while rotating. The paddles 134 were sufficiently hard to allow pushing against the crops without noticeable deformation, while being sufficiently soft to avoid damaging the crops. In at least one embodiment, both paddles 134 were circular in shape.

The electrical devices of the robot included one or more microcontrollers, power banks, relays, motors and motor drivers. In at least one embodiment there were two relays, two motors and two motor drivers. A schematic of the electrical system is shown in FIG. 3. The entire robot was powered by the power bank 150, and the microcontroller 122 controlled the various electronic devices. As an example, the microcontroller 122 controlled the frequency of the relays 160 to change the input power of the motors 155, and therefore controlled the output torque of both motors 155. The microcontroller 122 also controlled the rotation direction of the motors 155.

Provided as a non-limiting example, the motion of the agricultural robot system 100 was analyzed according to the following parameters.

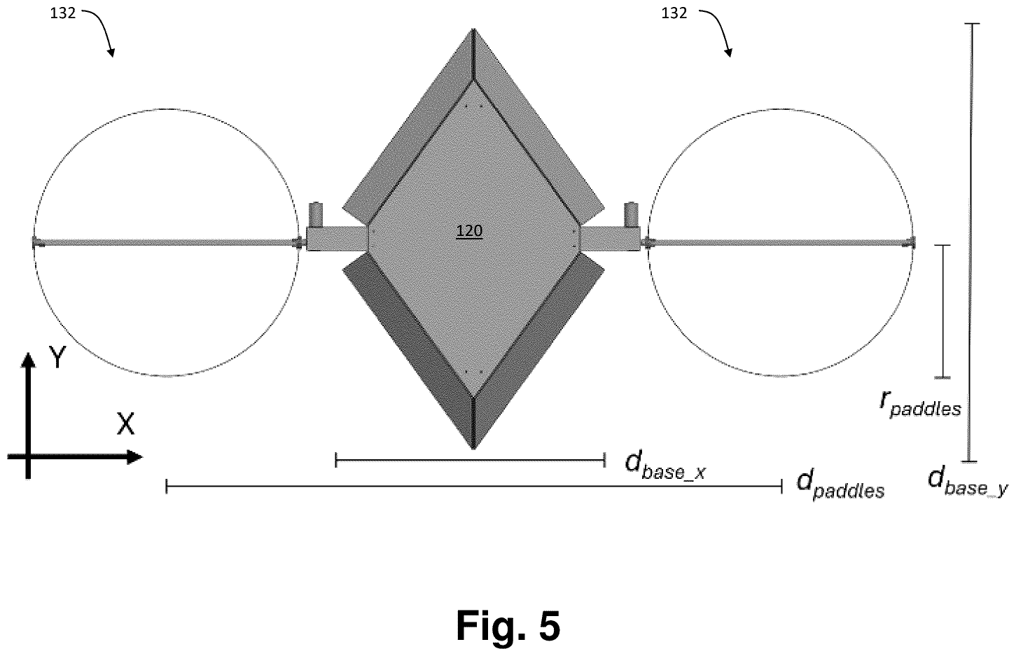

Prior to initiating the motion analysis calculations, it is imperative to ascertain a set of fundamental parameters. These encompass four critical dimensional measurements: two pertaining to the base (d_{base_x}, d_{base_y}), the distance between the paddle 134 centers (d_{paddles}), and the radius of each paddle 134 (r_{paddles}). FIG. 5 illustrates a non-limiting example of these dimensional parameters, providing a visual reference for their respective placements and scales.

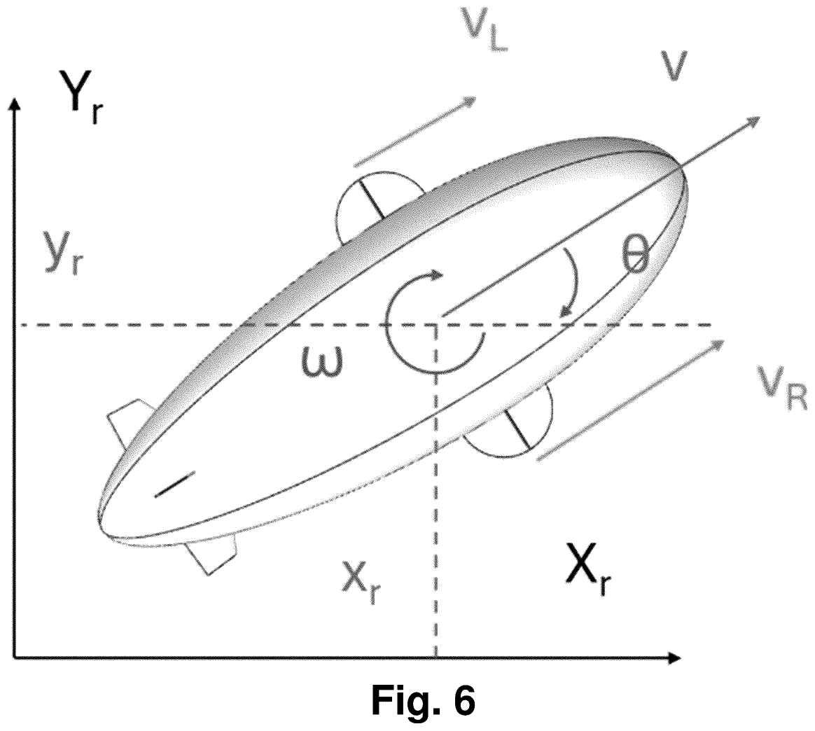

By looking at the robot 100 from above, the position of the robot 100 can be expressed as (xᵣ, yᵣ, θ), as shown in FIG. 6.

In this analysis, v is the linear velocity of the robot 100 and ω is the rotational velocity of the robot 100, with ω_{L} and ω_{R} being the rotational velocity of each of two paddles 134 (the Left and Right paddles 134), and v_{L} and V_{R} being the linear velocity of the robot 100 on each side. The relationship between ω_{L/R} and v_{L/R} can be expressed with the following equation.

$${v}_{L / R} = {ω}_{L / R} \times {r}_{paddles}$$

The kinematic relationship between velocities and the positions can be expressed as

$$\{ \begin{matrix}\frac{dx}{dt} = v \times cos ( θ ) \\ \frac{dy}{dt} = v \times sin ( θ ) \\ \frac{d θ}{dt} = ω\end{matrix}$$

As the robot 100 progresses across a crop field, it can encounter a significant drag force attributed primarily to the balloon 110, a major source of resistance. In wind-affected conditions, this drag force bifurcates into components along the x-axis (F_{drag_x}) and y-axis (F_{drag_y}).

To compute the drag force, it is necessary to determine several parameters: the sectional areas of the balloon 110 along the x and y axes (Aₓ and A_{y}), the air density (Pₐᵢᵣ), the drag coefficient (C_{drag}), and the wind velocity in the x and y direction (v_{wind_x} and v_{wind_y}). The formula for the x-axis drag force is

$${F}_{{drag}_{x}} = \frac{1}{2} {C}_{drag} {ρ}_{air} {A}_{x} {v}_{{wind}_{x}}^{2}$$

Conversely, when computing the y-axis drag force, the initial speed of the robot 100 (vᵢₙᵢₜ) is an essential factor. The corresponding equation is

$${F}_{{drag}_{x}} = \frac{1}{2} {C}_{drag} {ρ}_{air} {{A}_{y} ( {v}_{{wind}_{y}} - {v}_{init} )}^{2}$$

These equations enable precise quantification of the drag forces impacting the robot 100 under various environmental conditions.

The friction force (F_{fric}) between the robot 100 and the crops while the robot 100 is in motion can also be taken into consideration. The friction force is a result of the robot 100's downforce, which necessitates the determination of the robot 100's total mass (m_{boat}) and the buoyancy force provided by the balloon 110. The buoyancy force calculation requires the volume of the gas (e.g., helium gas) (Vₕₑₗᵢᵤₘ). The equation for computing the friction force is simplified as

$${F}_{fric} = - ( {m}_{boat} - {v}_{helium} ( {ρ}_{air} - {ρ}_{helium} ) ) g {μ}_{fric}$$

In this equation, μ_{fric} represents the coefficient of kinetic friction, a crucial variable in the calculation.

The friction torque (T_{fric}) between the robot 100 and the crops while the robot 100 is in rotating may also be taken into account. The friction torque is a result of the robot 100's friction force, which necessitates the determination of the robot 100's friction force and the shape of the base. IN example embodiments where the robot 100 has a diamond-shaped base, the formula for determining T_{fric} is:

$${T}_{fric} = \frac{1}{2} {F}_{fric} \sqrt{{d}_{{base}_{x}}^{2} + {d}_{{base}_{y}}^{2}}$$

This equation may help in accurately assessing the angular acceleration by considering the unique shape and frictional characteristics of the robot 100's base.

The acceleration (a) the angular acceleration (α) can be obtained by

$$\{ \begin{matrix}a = \frac{dv}{dt} \\ a = \frac{d ω}{dt}\end{matrix}$$

After determining both the acceleration and angular acceleration, the thrust force (Fₜₕᵣᵤₛₜ) of the robot 100 may be calculated by multiplying the acceleration by the robot 100's mass (m_{boat}). Similarly, the total rotation torque (M) may be obtained by multiplying the angular acceleration with the robot 100's moment of inertia (I_{boat}), which is influenced by the robot 100's shape. This leads to the following formulas for calculating the thrust force and rotational torque:

$$\{ \begin{matrix}{F}_{thrust} = a \times {m}_{boat} \\ M = α \times {I}_{boat}\end{matrix}$$

To obtain the output torque of each motor 155, the total pushing force (Fₚᵤₛₕ) and the rotational force (Fᵣₒₜₐₜₑ) provided by the paddles 134 can be used. Depending on the linear velocity's direction, the total pushing force (Fₚᵤₛₕ) exerted by both paddles 134 can be derived. This is accomplished by adjusting the thrust force to account for the drag force (F_{drag}) and either adding or subtracting the friction force (F_{fric}). The formula that encapsulates this relationship is:

$$\{ \begin{matrix}{F}_{push} = {F}_{thrust} - {F}_{drag} - {F}_{fric} & v \geq 0 \\ {F}_{push} = {F}_{thrust} - {F}_{drag} - {F}_{fric} & v < 0\end{matrix}$$

To determine the rotational force (Fᵣₒₜₐₜₑ), the torque produced by the paddles 134 can be calculated. This can be achieved by either adding or subtracting the total rotational torque from the friction torque (T_{fric}), depending on the direction of rotation. The resulting torque may be then divided by half the distance between the paddle 134 centers (d_{paddles}). The calculation may be expressed by the following formula:

$$\{ \begin{matrix}{F}_{rotate} = \frac{2 ( M - {T}_{firc} )}{{d}_{paddles}} & ω \geq 0 \\ {F}_{rotate} = \frac{2 ( M + {T}_{firc} )}{{d}_{paddles}} & ω < 0\end{matrix}$$

The total pushing force (Fₚᵤₛₕ) is the aggregate of the forces generated on each side of the robot 100 (F_{L} and F_{R}). Meanwhile, the rotational force (Fᵣₒₜₐₜₑ) can be derived from the difference in these pushing forces. Understanding these relationships is helpful in determining the individual pushing force on each side. Once these forces are calculated, multiplying them by the paddle 134 radius (r_{paddles}) yields the torque for each motor 155 (TL and TR). These equations are instrumental in predicting the motors' output torque based on a predefined trajectory.

Each paddle 134 on the robot 100 exerts a propulsive force, derived from the motor's torque and modulated by the paddle 134 radius (r_{paddles}). This force is important in determining the robot 100's velocity. The aggregate propulsive force (Fₚᵤₛₕ) is the cumulative effect of the forces generated by both paddles 134. Conversely, the rotational force (Fᵣₒₜₐₜₑ), crucial for maneuvering the robot 100, is calculated by the differential between the forces exerted by the individual paddles 134 (F_{L} and F_{R}). The mathematical expressions for these forces may be encapsulated by the following simplified equations:

$${F}_{push} = \frac{{T}_{L} + {T}_{R}}{{r}_{paddle}}$$

$${F}_{rotate} = \frac{{T}_{L} - {T}_{R}}{{r}_{paddles}}$$

The thrust force exerted by the robot 100 is a composite metric, calculated by summing the pushing force (Fₚᵤₛₕ) and the drag force along the y-axis (F_{drag_y}). This total may then be adjusted by either adding or subtracting the friction force (F_{fric}), contingent on the robot 100's direction of movement. Subsequently, the robot 100's acceleration (a) may be computed using Newton's Law, factoring in the robot 100's mass. The corresponding formula may be articulated as:

$$\{ \begin{matrix}a = \frac{{F}_{push} + {F}_{{drag}_{y}} + {F}_{fric}}{{m}_{boat}} & {v}_{init} \geq 0 \\ a = \frac{{F}_{push} + {F}_{{drag}_{y}} - {F}_{fric}}{{m}_{boat}} & {v}_{init} < 0\end{matrix}$$

To determine the robot 100's angular acceleration, a calculation of the total rotation torque (M) may be used. This torque, generated by the paddles 134, may be computed as the product of the rotational force and half the distance between the paddle 134 centers (d_{paddles}). Depending on the rotational direction, the friction torque (T_{fric}) may then either be added to or subtracted from this value. The formulation for this calculation is succinctly captured in the following equations:

$$\{ \begin{matrix}M = \frac{1}{2} {F}_{rotate} {d}_{paddles} + {T}_{firc} & {ω}_{init} \geq 0 \\ M = \frac{1}{2} {F}_{rotate} {d}_{paddles} - {T}_{firc} & ω < 0\end{matrix}$$

Once the rotation torque is calculated, the torque may then be divided by the robot 100's moment of inertia (I_{boat}), which is primarily determined by the robot 100's shape. This computation yields the angular acceleration (α). The formula for this calculation is presented as:

$$α = \frac{M}{{I}_{boat}}$$

These equations may allow for a precise determination of the robot 100's angular acceleration, considering both the generated torque and the resistance due to friction. Upon establishing the relationship between the motor's output torque and both the acceleration and angular acceleration, it becomes feasible to calculate the robot 100's velocity and angular velocity, which can predict the robot 100's travel distance and trajectory.

Understanding these dynamics allows for accurate modeling of the robot 100's movement, providing valuable insights into its operational capabilities and efficiency in various environments.

The following example simulation uses the results from a motion analysis of the embodiments depicted in FIGS. 1 and 2 to simulate the mathematical model of a non-limiting simulated design by MATLAB. Parameters of the simulation are listed in Table 1. This simulation is intended to validate the design model against theoretical kinematic equations and relationships, assessing its performance. Notably, three simulations were conducted under the assumption of no wind impact. These simulations assist in understanding how the model of the embodiments depicted in FIGS. 1 and 2 behave under controlled conditions and provide valuable insights into the efficacy of these embodiments.

TABLE 1
Parameters Used a Simulated Design

| Parameter | Value | |
|---|---|---|
| d_{base}_{_{—}}ₓ | 0.6 | m |
| r_{paddles} | 0.3 | m |
| Aₓ | 21 | m² |
| Vₕₑₗᵢᵤₘ | 4.6 | m³ |
| C_{drag} | 0.5 | |
| d_{base}_{_{—}}_{y} | 1 | m |
| d_{paddles} | 1.2 | m |
| A_{y} | 7 | m² |
| m_{boat} | 6 | kg |

| | |
|---|---|
| μ_{fric} | 0.3 |

The first simulation uses a forward dynamics method. It initiates with randomly generated torque values for both motors 155 for 10 seconds. Utilizing the outcomes from the motion analysis, MATLAB calculated the robot 100's velocity, angular velocity and trajectory. The simulation results, including graphs of motor torque versus time, velocity versus time, angular velocity versus time and the robot 100's trajectory, are depicted in FIG. 7. Notably, the trajectory graph illustrates the model's location in x and y coordinates at every 0.01s interval, commencing from the origin (0,0).

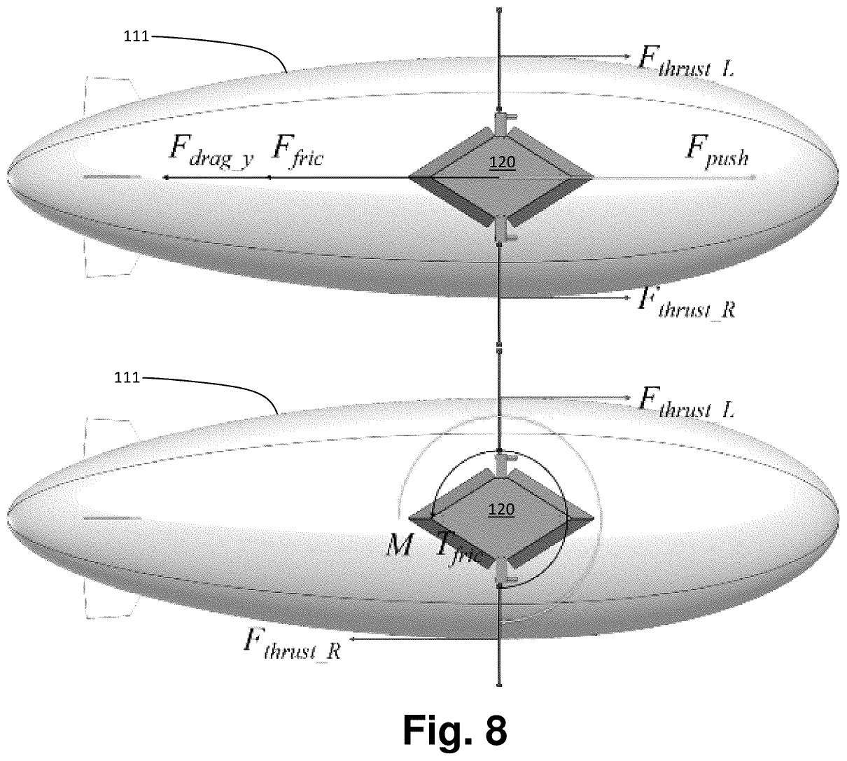

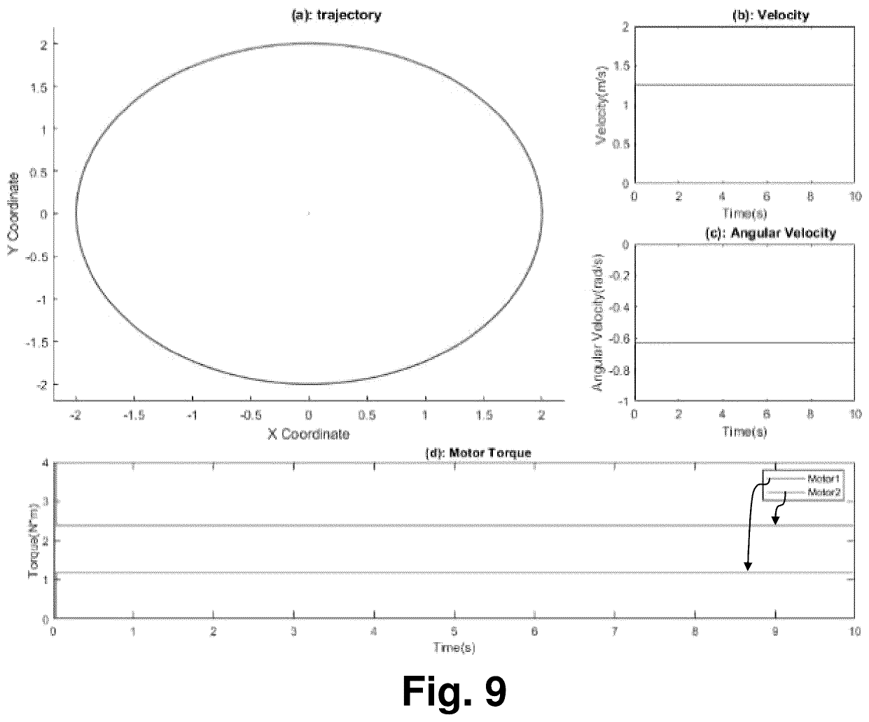

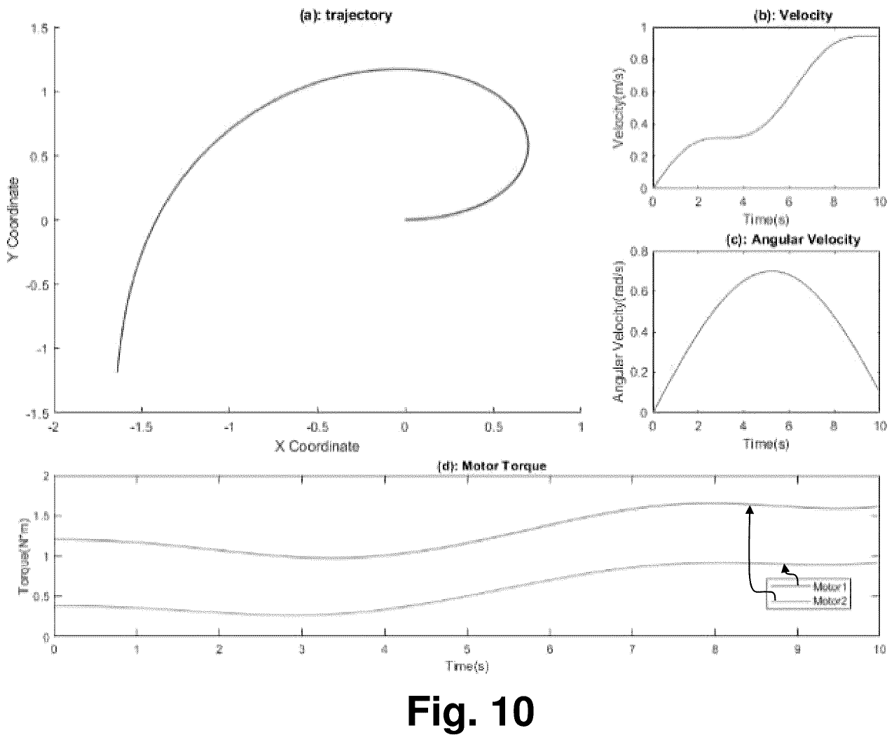

The second and third simulations utilize an inverse dynamics model. For the convenience of analysis, a Free Body Diagram (FBD) of the vehicle as depicted in FIG. 8 was used. They begin by generating a predefined moving trajectory, represented by a series of x and y coordinates, each marking the robot 100's location at 0.01s intervals. The second simulation starts with a circular trajectory, and the third simulation starts with a random curved trajectory. From these coordinates, the robot 100's velocity and angular velocity at each moment are calculated, followed by the computation of its acceleration and angular acceleration. This inverse-engineering approach utilizes the theoretical relationships derived from motion analysis to link these dynamics to motor torques. The results, including graphs for motor torque versus time, velocity versus time, angular velocity versus time, and the model's trajectory, are illustrated in FIG. 9 and FIG. 10.

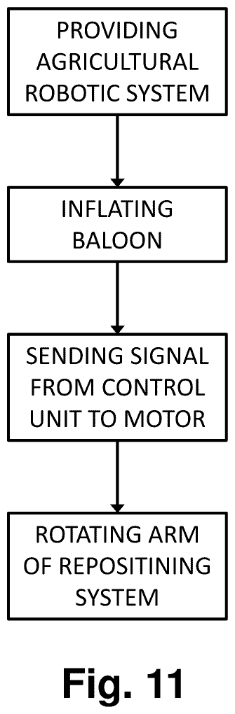

In certain embodiments, the agricultural robot system 100 of the present disclosure may be provided in various ways. For instance, the agricultural robot system 100 may be used according to a method. As shown in FIG. 11, the method may include a step of inflating the balloon 110 with a gas that is less dense than air. The method may also include a step of sending a signal from the control unit to the motor 155 of the repositioning system 130. In another step, the motor 155 may rotate the arm 132.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

Reference systems that may be used herein can refer generally to various directions (e.g., upper, lower, forward and rearward), which are merely offered to assist the reader in understanding the various embodiments of the disclosure and are not to be interpreted as limiting.

To clarify the use of and to hereby provide notice to the public, the phrases “at least one of A, B, . . . and N” or “at least one of A, B, . . . N, or combinations thereof” or “A, B, . . . and/or N” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. As one example, “A, B and/or C” indicates that all of the following are contemplated: “A alone,” “B alone,” “C alone,” “A and B together,” “A and C together,” “B and C together,” and “A, B and C together.” If the order of the items matters, then the term “and/or” combines items that can be taken separately or together in any order. For example, “A, B and/or C” indicates that all of the following are contemplated: “A alone,” “B alone,” “C alone,” “A and B together,” “B and A together,” “A and C together,” “C and A together,” “B and C together,” “C and B together,” “A, B and C together,” “A, C and B together,” “B, A and C together,” “B, C and A together,” “C, A and B together,” and “C, B and A together.”

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

### Element Numbering

Table 2 includes element numbers and at least one word used to describe the element and/or feature represented by the element number. However, none of the embodiments disclosed herein are limited to these descriptions. Other words may be used in the description or claims to describe a similar member and/or feature, and these element numbers can be described by other words that would be understood by a person of ordinary skill reading and reviewing this disclosure in its entirety.

TABLE 2

| | |
|---|---|
| 100 | robot |
| 110 | balloon |
| 111 | Zeppelin-shaped balloon |
| 120 | housing |
| 122 | processor(s) |
| 130 | repositioning system |
| 132 | arm |
| 134 | paddle |
| 136 | axle |
| 150 | energy storage system |
| 155 | motor |
| 160 | relay |

What is claimed is:

1. An agricultural robotic system configured to move over a crop field, comprising:
a housing;
a balloon connected to the housing; and
a repositioning system connected to the housing, wherein the repositioning system is configured to provide a propulsive force for the housing by pushing against the crop.

2. The agricultural robotic system of claim 1, wherein the repositioning system includes at least two arms extending horizontally from the housing.

3. The agricultural robotic system of claim 2, wherein each of the at least two arms include
a rotating axle, and
one or more curved paddles connected to the rotating axle, wherein rotation of the rotating axle results in rotation of the one or more curved paddles.

4. The agricultural robotic system of claim 3, wherein the arm includes carbon fiber material.

5. The agricultural robotic system of claim 1, wherein the balloon is substantially Zeppelin shaped.

6. The agricultural robotic system of claim 1, wherein the housing includes at least one tapered surface.

7. The agricultural robotic system of claim 6, wherein the housing is boat-shaped with at least two angled surfaces positioned to be closer together at the bottom of the housing than at the top of the housing and the two angled surfaces meeting to form a wedge-like bow.

8. The agricultural robotic system of claim 1, wherein the housing includes a processor, an energy storage system and a control unit.

9. The agricultural robotic system of claim 2, wherein housing further includes a communication system enabling wireless communication between the control unit and a user.

10. A method of using an agricultural robotic system, the method comprising:
obtaining an agricultural robotic system including
a housing,
a control unit positioned within the housing,
a balloon coupled to the housing, and
a repositioning system coupled to the housing, the repositioning system including
a motor and
an arm configured to push against one or more plants in an agricultural field;
inflating the balloon with a gas that is less dense than air resulting in the agricultural robotic system hovering near the top of the plants in an agricultural field;
sending a signal from the control unit to the motor of the repositioning system; and
rotating the arm of the repositioning system via the motor, wherein said rotating results in the arm pushing against a plant in the agricultural field.

11. The method of claim 10, wherein
the repositioning system includes at least two arms extending horizontally in opposite directions from the housing,
said rotating the arm includes rotating the at least two arms, and
said rotating results in the at least two arms pushing against one or more plants in the agricultural field.

12. The method of claim 11, wherein said rotating the at least two arms includes rotating the at least two arms in different directions.

13. The method of claim 11, wherein said rotating the at least two arms includes rotating the at least two arms in the same direction.

14. The agricultural robotic system of claim 1, further comprising:
communicating information between the control unit and a user.

15. An agricultural robotic system configured to move over a crop field, comprising:
a housing;
a balloon connected to the housing; and
means for repositioning the housing, wherein said means includes a member that touches and pushes against at least one plant in a crop field.

16. The agricultural robotic system of claim 15, wherein said means includes at least two rotating arms extending horizontally from the housing, each of the at least two arms including a member that touches and pushes against at least one plant in a crop field.

17. The agricultural robotic system of claim 16, wherein said means includes:
means for rotating the housing by rotating the at least two arms in opposite directions; and
means for linearly moving the housing by rotating the at least two arms in the same direction.

18. The agricultural robotic system of claim 16, wherein each of the at least two arms is curved.

19. The agricultural robotic system of claim 15, wherein the balloon is substantially Zeppelin shaped.

20. The agricultural robotic system of claim 15, wherein the housing is boat-shaped with at least two angled surfaces positioned to be closer together at the bottom of the housing than at the top of the housing and the two angled surfaces meeting to form a wedge-like bow.
